(19) United States
(12) Patent Application Publication
(10) Pub. No.: US 2016/0139888 A1
(43) Pub. Date: May 19, 2016

(54) AUTOMATED APP GENERATION SYSTEM

(71) Applicant: AppsFreedom, Inc., Chandler, AZ (US)

(72) Inventors: VAIDYANATHAN IYER, CHANDLER, AZ (US); VIKAS GUPTA, NAPERVILLE, IL (US)

(73) Assignee: APPSFREEDOM, INC., Chandler, AZ (US)

(21) Appl. No.: 14/942,670

(22) Filed: Nov. 16, 2015

Related U.S. Application Data
(60) Provisional application No. 62/079,585, filed on Nov. 14, 2014.

(51) Int. Cl. G06F 9/44; G06Q 10/06; G06F 3/0482; G06F 3/0486; G06F 3/0484

(52) U.S. Cl. CPC G06F 8/34; G06F 3/0486; G06F 3/04842; G06F 3/0482; G06F 8/35; G06Q 10/0633

(57) ABSTRACT

An app development platform that provides a unique way for anyone, without any programming skills, to build and deploy apps in 5 easy steps. Typically the entire end-to-end 5 step process from app conceptualization to app deployment can be done in 5 days or less. The platform is a Model-Driven platform that guides anyone with no programming skills through 5 steps that include 1) define the process; 2) enhance the screens; 3) build integration logic; 4) publish and manage; and 5) analyze user behavior.

### BACKGROUND OF THE INVENTION

1. Technical Field

This invention relates generally to an app development platform and more particularly to an automated app development platform that provides a unique way for anyone, without any programming skills, to build and deploy apps in 5 easy steps.

2. State of the Art

The development of apps for computing devices and particularly mobile computing devices is becoming more important within businesses. Businesses seek to develop apps in order to improve productivity by giving the businesses the ability to simplify the tasks of various employees of the business by developing an app that help in the performance of the employees responsibilities. Currently, there is not a system that allows a user with no programming experience to be able to develop an app for enterprises, across all mobile OS and browsers, completely integrated to IT's core business applications.

Accordingly, there is a need in the field of app development for an improved automated app development platform.

### DISCLOSURE OF THE INVENTION

The present invention relates to an app development platform that provides a unique way for anyone, without any programming skills, to build ,deploy and manage apps in 5 easy steps.

Embodiments of the present invention include a method of automatically generating an app with an app generation system. The method comprises the steps of defining a business process, wherein designing a business process includes creating a flow chart of the business process using a drag and drop user interface; automatically generating an app for all operating systems in response to activating an app generation software application, wherein no user input beyond the business process flow chart is required to generate the app; enhancing the visual aspects of screens of the generated app; building integration logic using a drag and drop interface; publishing and managing the generated app; and analyzing user behavior, wherein the generation of the app includes providing automatic reporting of user behavior in use of the generated app.

Another embodiment includes a system for automatically generating an app with a app generation system, the system comprising: a process modeler module presented on the electronic display of a user, wherein the process modeler is operable by a user for defining a business process, wherein defining a business process includes creating a business process flow chart of the business process using a drag and drop user interface of the process modeler module; automatically generating an app in response to activating an app generation software application by clicking on an a generate button provided by operation of the system, wherein no user input beyond the business process flow chart is required to generate the app; an app designer module presented on the electronic display of a user, wherein the app designer module provides for enhancing the visual aspects of screens of the generated app; an integration builder module presented on the electronic display of a user, wherein the integration builder module operates for building integration logic using a drag and drop interface; a platform configurator module, wherein the platform configurator module is presented on the electronic display of a user, publishing and managing the generated app; and a management develop interface for analyzing user behavior, wherein the generation of the app includes providing automatic reporting of user behavior in use of the generated app.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a view of a process modeler of an app generation system.

FIG. 2 is a view of an app designer module of an app generation system.

FIG. 3 is a view of an integration builder of an app generation system.

FIG. 4 is a view of a platform configurator of an app generation system.

FIG. 5 is a view of a management development interface of an app generation system.

FIG. 6 is a flow chart of a method of generating an app automatically.

### DETAILED DESCRIPTION OF EMBODIMENTS OF THE INVENTION

As discussed above, embodiments of the present invention relate to an app development platform that provides a unique way for anyone, without any programming skills, to build and deploy apps in 5 easy steps. Typically the entire end-to-end 5 step process from app conceptualization to app deployment can be done in 5 days or less. The platform is a Model-Driven platform that guides anyone with no programming skills through a method of automated app generation.

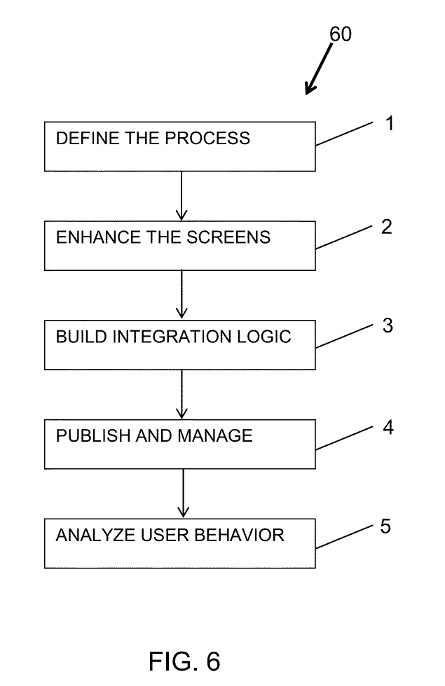

Referring to FIG. 6, a method or process 60 of generating an app automatically comprises 5 steps in accordance with embodiments. The method 60 may include define the process (Step 1); enhance the screens (Step 2); build integration logic (Step 3); publish and manage (Step 4); and analyze user behavior (Step 5).

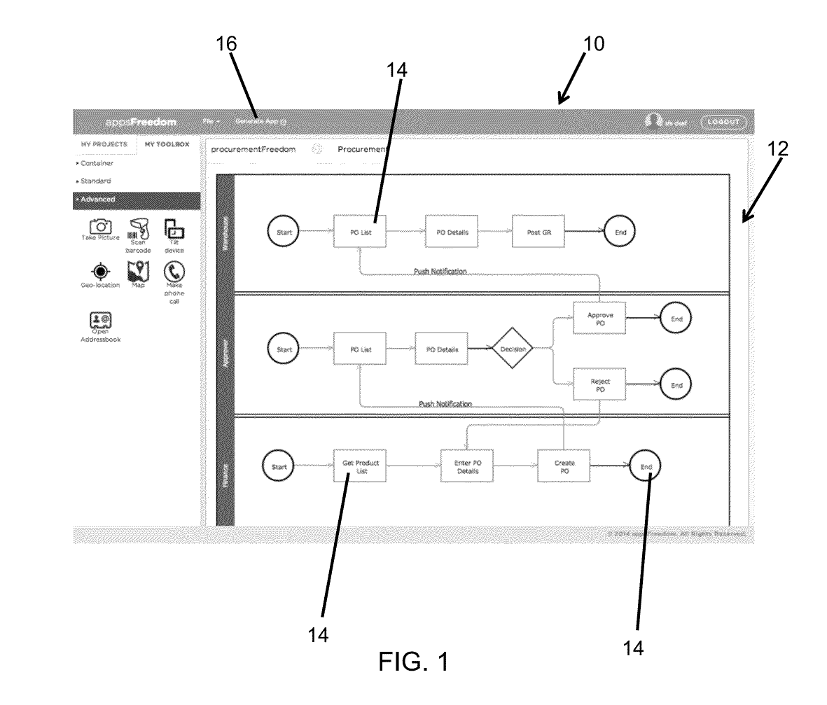

FIGS. 1-5 depict the various components of the system, and further provide additional method steps in the description of the modules that operate during each step of the app generation process 60.

### Step 1: Define the Process

In the system platform, a user may access the Process Modeler module 10, shown in FIG. 1, and define the business processes 12 for the app to be created. This can be performed with drag and drop process components 14. The focus should be on the logical process model, not on the user interface (“UI”) or backend systems and data. The primary step is to get the processes 12 completely right and it ensures that the app is designed exactly the way the end-user requires without compromising on user experience (“UX.”) Unlike other app development systems, embodiments of the system platform allows for a model of a business process 12 be the foundation for the automated generation of an app.

A user clicks on a “GENERATE APP” button 16 in the Process Modeler 10 which generates the base app framework for all device operating systems (i.e. iOS, Android, Blackberry, Windows smartphones & tablets) and the browser. At this point, the system platform has automatically generated an app with all the logic and navigation flow embedded. However, the generated app will not have all the desired screen elements or cosmetic look and feel of the user interface at this step.

### Step 2: Enhance the Screens

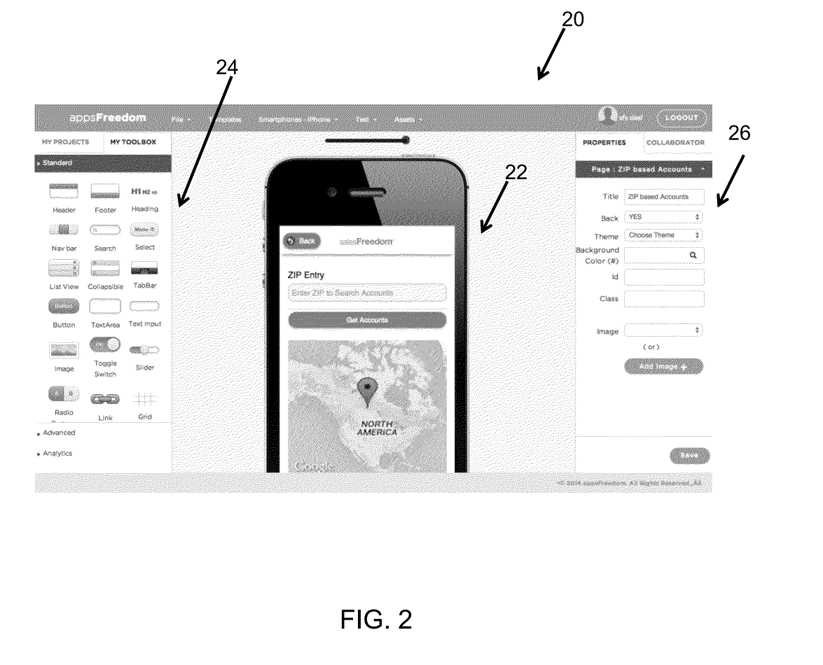

The user may then access the App Designer Module 20, as depicted in FIG. 2, in the system platform and open the app 22 that was generated from the Process Modeler 10. This app 22 will have various pages, and the relationship between them, if there is such. In the App Designer Module 20, a user can open each page and drag-and-drop mobile components 24 into the UI. The mobile components 24 can be from simple elements like dropdown and text boxes to more advanced elements like charts and bar-code scanners. Any enhancement needs to be made only once and the system applies any enhancement made in one operating system app 22 to all the devices and browsers operating in different operating systems. All the app enhancements can be reviewed in real-time by business users from their devices for real-time feedback to the app developer.

### Step 3: Build Integration Logic

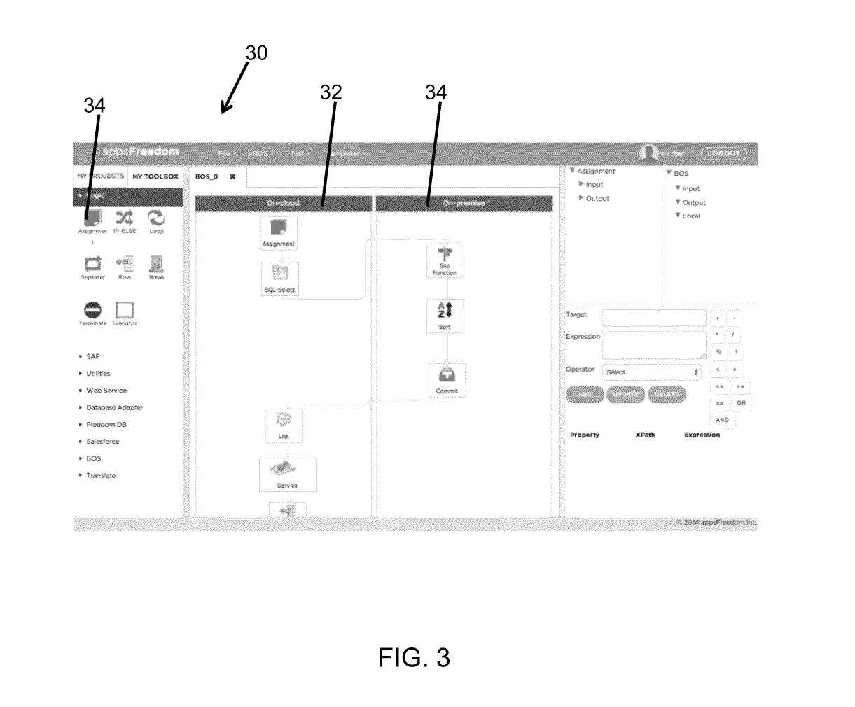

For this task, open the Integration Builder, as seen in FIG. 3 in the system platform and start building the integration logic for the generated app 22. This may include connecting to a cloud backend application 32 or an on-premise backend application 34 or to no external application at all, depending on the specific requirements of the app 22. This activity includes building the business and integration logic required by the app 22. All business and integration logic is done via drag-and-drop components 36 in the Integration Builder Module 30. The app development process is complete at this step.

### Step 4: Publish and Manage

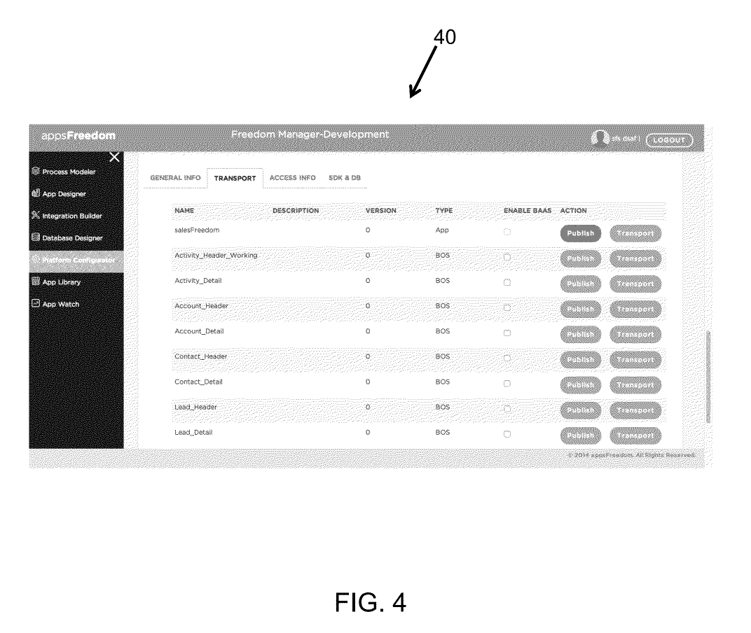

In this step, publish the app using a Platform Configurator Module 40 of the system platform, as shown in FIG. 4. In this step, administration tasks such as user definition and role assignment can be leveraged from the backend identity management servers. This module also includes testers into the process to test the app before publishing and rolling it out to production users and managing it.

### Step 5: Analyze User Behavior

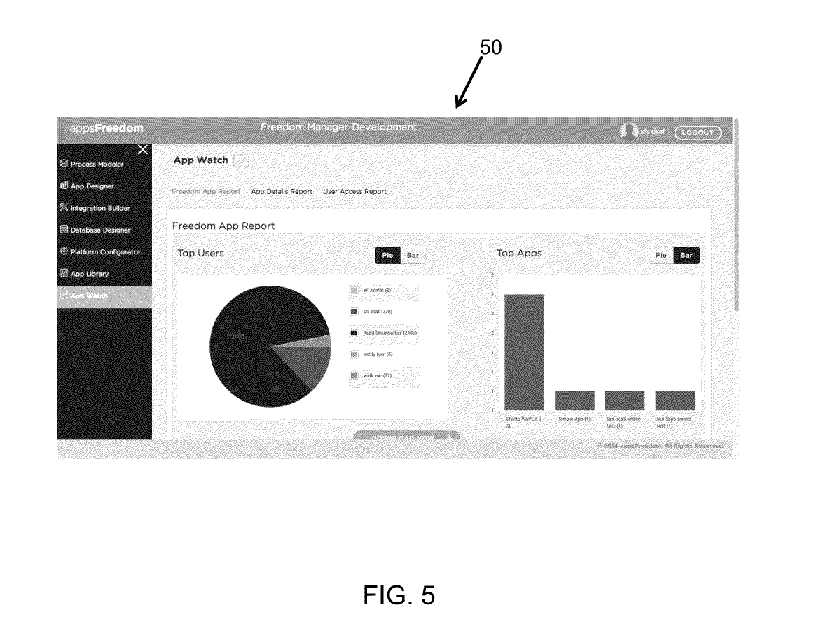

Once business users have downloaded and deployed the app, the apps automatically provides all usage statistics to the platform where the developer or administrator can analyze usage and user behavior patterns to update the app with improvements using a Management Development Interface or App Watch 50 as depicted in FIG. 5.

The system platform supports the complete app development lifecycle with this 5 step process. All of the steps of the process are provided by the use of a software application that provides a user interface for each step. Based on the information entered by the user at the beginning with the business process model, the software application automatically generates an app that performs the functionality to accomplish the business process. There is no need for a user to code and debug the code in order to create a working app.

While the invention has been shown and described with reference to specific preferred embodiments, it should be understood by those skilled in the art that various changes in form and detail may be made therein without departing from the spirit and scope of the invention as defined by the following claims.

1. A method of automatically generating an app with a app generation system, the method comprising:
defining a business process, wherein defining a business process includes creating a business process flow chart of the business process using a drag and drop user interface;
automatically generating an app in response to activating an app generation software application, wherein no user input beyond the business process flow chart is required to generate the app;
enhancing the visual aspects of screens of the generated app;
building integration logic using a drag and drop interface;
publishing and managing the generated app; and
analyzing user behavior, wherein the generation of the app includes providing automatic reporting of user behavior in use of the generated app.

2. The method of claim 1, wherein automatically generating an app includes automatically generating an app for an operating system.

3. The method of claim 2, wherein the operating system comprises one of a smartphone operating system or a browser.

4. The method of claim 3, wherein the smartphone operating system comprises any operating system for a smartphone.

5. The method of claim 1, wherein enhancing the visual aspects of the screens includes using a drag and drop interface for dragging and dropping mobile components into the user interface.

6. The method of claim 5, further comprising reviewing app enhancements in real-time by business users from their devices for real-time feedback to the app developer.

7. A system for automatically generating an app with a app generation system, the system comprising:
a process modeler module presented on the electronic display of a user, wherein the process modeler is operable by a user for defining a business process, wherein defining a business process includes creating a business process flow chart of the business process using a drag and drop user interface of the process modeler module;
automatically generating an app in response to activating an app generation software application by clicking on an a generate button provided by operation of the system, wherein no user input beyond the business process flow chart is required to generate the app;
an app designer module presented on the electronic display of a user, wherein the app designer module provides for enhancing the visual aspects of screens of the generated app;
an integration builder module presented on the electronic display of a user, wherein the integration builder module operates for building integration logic using a drag and drop interface;
a platform configurator module, wherein the platform configurator module is presented on the electronic display of a user, publishing and managing the generated app; and
a management develop interface for analyzing user behavior, wherein the generation of the app includes providing automatic reporting of user behavior in use of the generated app.

8. The system of claim 7, wherein automatically generating an app includes automatically generating an app for all operating systems.

9. The system of claim 7, wherein app designer module operates to enhance the visual aspects of the screens includes using a drag and drop interface for dragging and dropping mobile components into the user interface.

10. The method of claim 9, further comprising reviewing app enhancements in real-time by business users from their devices for real-time feedback to the app developer.

11. The system of claim 7, wherein the integration builder module operates to connect to a cloud backend application an on-premise backend application, or to no external application depending on the specific requirements of the app.

12. The system of claim 7, wherein the platform configurator module performs administration tasks comprising user definition and role assignment, wherein the administration tasks can be leveraged from the backend identity management servers.

13. The system of claim 7, wherein the management development interface automatically provides all usage statistics to the platform for analyzing usage and user behavior patterns to update the app with improvements.
